(19) United States
(12) Patent Application Publication
(10) Pub. No.: US 2020/0073967 A1
(43) Pub. Date: Mar. 5, 2020

(54) TECHNIQUE FOR SAVING METADATA ONTO PHOTOGRAPHS

(71) Applicant: Sony Corporation, Tokyo (JP)

(72) Inventor: Brant Candelore, Escondido, CA (US)

(21) Appl. No.: 16/114,919

(22) Filed: Aug. 28, 2018

(51) Int. Cl. G06F 17/30

(52) U.S. Cl. CPC G06F 17/30265; G06T 2200/21; G06F 17/3012

(57) ABSTRACT

Metadata concerning a photograph is saved onto the photograph in a visible and innocuous way soon after the photograph is captured. The metadata may be generated locally on the imaging device or from a server in communication with the imaging device after analyzing the photograph.

### FIELD

The present application relates to technically inventive, non-routine solutions that are necessarily rooted in computer technology and that produce concrete technical improvements.

### BACKGROUND

A digital photograph can have associated tag-along metadata files.

A digital photograph can also have included metadata associated with it such as the Exchangeable Image File Form (EXIF) and international Press Telecommunications Council (IPTC) data. These mostly provide information about the camera make, model and settings that took the image, but can also include automatic information, such as location with devices with GPS, and manually added details by someone editing the picture file at a computer. However, there have been problems with the adoption of the EXIF and IPTC fields. They are limited in size, and hold proprietary data to a camera manufacturer which makes the fields not readable by all applications, and even cause image rendering problems. Consequently, a number of image editors delete the EXIF and IPTC information from the digital image file to make the image more universally renderable. Another issue is that there could be multiple versions of a photograph . . . one that has been edited to add metadata and others that did not include that data, e.g. the photograph was shared with others before the metadata was manually added to the photograph.

As understood herein, the separate tag-along metadata files or included metadata fields can be lost. Standards can change and old metadata formats obsoleted. In some cases, the digital images are printed on paper to be included in physical albums, and the entire digital image lost. Furthermore, the creation date on the image file can be changed when the image is copied or transferred from camera internal storage or recordable media to a PC, or just media to other media. As a result, people possessing such photographs may lose information as to where the photograph was taken, who the people in the photograph are, the nature of the event captured by the photograph, the date of the event, and so on. While file names may be designed to provide limited information such as date and time, the file name size is limited, so other data cannot be placed there.

### SUMMARY

Present principles recognize the above problems and so provide techniques for superimposing metadata such as location information onto a digital photograph in a designated part of the image. The imaging device such a Sony Alpha™ or RX100 series of dedicated cameras or built-in to the Sony Experia® smart phones (or a server in communication therewith) may also perform image recognition to generate metadata representing names of people and objects such as buildings in the photograph to generate additional metadata that may be superimposed on the photograph as close to the time the photograph was taken as possible and before it is shared with other people. In lieu of or in addition to image recognition, the user may be prompted to enter names of people and objects in the photograph to establish metadata. To identify people and things, the camera may communicate and upload the photograph with a service such as Google® or Facebook® (and the information from the user's account) and then populate metadata fields in the image below each person. Other useful data can be super-imposed on the photograph. Note that two photographs may be created from a single shutter operation, one untouched and the other one with the metadata encoded into the image with the information that it is able to ascertain.

The metadata may be superimposed so that it is visible to the eye by overwriting metadata onto image pixels representing pixel values such as grayscale values. The metadata may also appear as type of watermark which can be read, but with transparency to make more subtle.

It is possible that the lower part of the image could contain the metadata. Or that the metadata is attached to the image below the image so that it does not interfere with the image taken.

Accordingly, an assembly includes a housing. At least one processor is in the housing, and at least one imager is supported on the housing and is configured to communicate with the processor. At least one computer storage also is in the housing and includes instructions executable by the processor to render a first photograph. The instructions are executable to render metadata that includes at least one of: information pertaining to when the photograph was taken, information pertaining to the location of where the photograph was taken, information pertaining to at least one person in the photograph, information pertaining to at least one non-human object in the photograph. The instructions can be executed to visually encode the metadata onto the photograph.

In some examples, the instructions are executable to encode the metadata onto the photograph by overwriting pixel values of the photograph with graphic data representing the metadata such that the metadata is visible on the photograph to a human eye. In some embodiments, the metadata may be visible on the photograph as a type of watermark where the text is translucent and allowing some of the background of the photograph to come through. The instructions may also be executable to encode the metadata onto the photograph by presenting in a non-image margin of the photograph graphic data representing the metadata such that the metadata is visible on the photograph to a human eye.

In another aspect, a computer storage device that is not a transitory signal includes downloadable instructions executable by at least one processor to render metadata including at least one of: information pertaining to when a photograph was taken, information pertaining to at least one person in the photograph, information pertaining to at least one non-human object in the photograph. The instructions are executable to encode the metadata onto the photograph.

In another aspect, a method includes generating a digital still image, and superimposing metadata including information about the digital still image onto the digital still image so that the metadata accompanies the digital file in the still image.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 is a view of a camera implemented as a standalone device;

FIG. 3 is a view of a camera implemented as a mobile telephone;

FIG. 4 is a flow chart of example logic of a first embodiment consistent with present principles;

FIGS. 5-7 are screen shots of photographs generated using the logic of FIG. 4;

FIG. 8 is a screen shot of an example user interface (UI) that may be used to support the logic herein;

### DETAILED DESCRIPTION

This disclosure relates generally to computer ecosystems including aspects of consumer electronics (CE) device-based user information in computer ecosystems. A system herein may include server and client components, connected over a network such that data may be exchanged between the client and server components. The client components may include one or more computing devices including imaging devices such as standalone digital cameras and cameras in mobile telephones, alone or in conjunction with portable televisions (e.g. smart TVs, Internet-enabled TVs), portable computers such as laptops and tablet computers, and other mobile devices. These client devices may operate with a variety of operating environments. For example, some of the client computers may employ, as examples, operating systems from Microsoft, or a Unix operating system, or operating systems produced by Apple, Inc. or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscribe line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

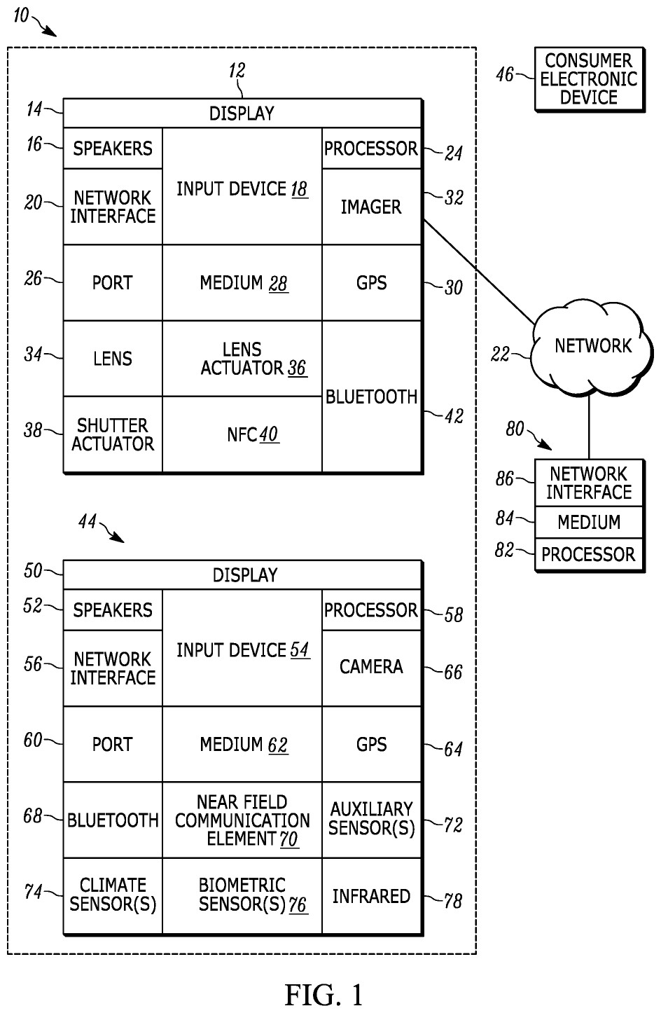

Now specifically referring to FIG. 1, an example ecosystem 10 is shown, which may include one or more of the example devices mentioned above and described further below in accordance with present principles. The first of the example devices included in the system 10 is an example imaging device (ID) 12 that may be a standalone imaging device, or an imaging device incorporated in another apparatus such as a mobile telephone, mobile computer, etc. Regardless, it is to be understood that the ID 12 is configured to undertake present principles (e.g. communicate with other CE devices to undertake present principles, execute the logic described herein, and perform any other functions and/or operations described herein).

Accordingly, to undertake such principles the ID 12 can be established by some or all of the components shown in FIG. 1. For example, the ID 12 can include one or more displays 14 that may be touch-enabled for receiving consumer input signals via touches on the display. The ID 12 may include one or more speakers 16 for outputting audio in accordance with present principles, and at least one additional input device 18 such as e.g. an audio receiver/microphone for e.g. entering audible commands to the ID 12 to control the ID 12, control keys for entering commands and/or data, etc. The example ID 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. The one or more interfaces 20 may include a wireless telephony transceiver such as but not limited to global systems for communication (GSM) transceiver, a code division multiple access (CDMA) transceiver including w-CDMA, an orthogonal frequency division multiplex (OFDM) transceiver, etc.

It is to be understood that the processor 24 controls the ID 12 to undertake present principles, including the other elements of the ID 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or transceiver as mentioned above, etc.

In addition to the foregoing, the ID 12 may also include one or more input ports 26 such as, a USB port to physically connect (e.g. using a wired connection) to another CE device and/or a headphone port to connect headphones to the ID 12 for presentation of audio from the ID 12 to a consumer through the headphones. The ID 12 may further include one or more computer memories 28 that are not transitory signals, such as disk-based or solid-state storage (including but not limited to flash memory). Also, in some embodiments, the ID 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the ID 12 is disposed in conjunction with the processor 24. However, it is to be understood that that another suitable position receiver other than a cellphone receiver, GPS receiver and/or altimeter may be used in accordance with present principles to e.g. determine the location of the ID 12 in e.g. all three dimensions.

Continuing the description of the ID 12, in some embodiments the ID 12 may include one or more imagers 32 that may be, e.g., a thermal imaging camera, a digital camera such as a webcam, and/or a camera integrated into the ID 12 and controllable by the processor 24 to gather pictures/images and/or video in accordance with present principles. An imager may be implemented by, without limitation, a charge-coupled device (CCD) or complementary metal-oxide-semiconductor (CMOS) device.

Light from objects may enter the imager 32 through one or more lenses 34. The lens 34 may be movable by a lens actuator 36 to focus the image on the imager 32. Without limitation, the imager 32 with lens 34 may be implemented in a digital single lens reflex (DSLR) package.

One or more shutter actuators 38 may be provided on the ID 12. The shutter actuator 38 can be manipulated to cause a shutter to open or otherwise “take” a picture. The shutter actuator may be implemented by s hardware key or soft key.

Also included on the ID 12 may be a Bluetooth transceiver 42 and other Near Field Communication (NFC) element 40 for communication with other devices using Bluetooth and/or NFC technology, respectively. An example NFC element can be a radio frequency identification (RFID) element. A battery (not shown) may be provided for powering the ID 12.

Still referring to FIG. 1, in addition to the ID 12, the system 10 may include one or more other CE device types. In one example, a first CE device 44 may be used to exchange photographic and video information with the ID 12 and/or with the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network.

The example non-limiting first CE device 44 may be established by any one of the above-mentioned devices, for example, an internet-enabled TV, a portable wireless laptop computer or tablet computer or notebook computer, and accordingly may have one or more of the components described below. The first CE device 44 alternatively may be embodied in the form of eyeglasses or a wireless telephone. The second CE device 46 without limitation may be established by a wireless telephone. The second CE device 46 may implement a portable hand-held remote control (RC).

The first CE device 44 may include one or more displays 50 that may be touch-enabled for receiving consumer input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 may control the first CE device 44 to undertake present principles, including the other elements of the first CE device 44 described herein such as e.g. controlling the display 50 to present images hereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a USB port to physically connect (e.g. using a wired connection) to another CE device such as the ID 12 and/or a headphone port to connect headphones to the first CE device 44 for presentation of audio from the first CE device 44 to a consumer through the headphones. The first CE device 44 may further include one or more computer memories 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44.

The second CE device 46 may include some or all of the components shown for the CE device 44.

Now in reference to the afore-mentioned at least one server 80, it includes at least one server processor 82, at least one computer memory 84 such as disk-based or solid-state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

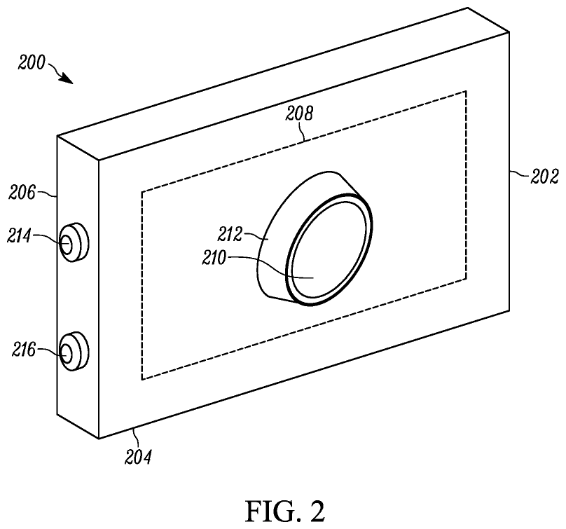

FIG. 2 illustrates a first example implementation of the ID 12, showing a standalone camera device 200 with a housing 202 containing components described above and having a front 204 and a back 206 (relative to the user, with the back 206 facing the user when in use to take pictures). A display 208 (shown in phantom in FIG. 2) may be part of the back 206 of the camera device 200. The display 208 can present images as generated by the imager within the housing 202.

As shown in FIG. 2, the camera device 200 may include a lens 210 that may be moved be a lens actuator 212 to focus the image on the imager behind the lens (not shown). In the example of FIG. 2, a shutter actuator button 214 is on the housing 202 and can be manipulated to capture an image to “take a picture” as a digital photograph. If desired, one or more lamps 216 such as light emitting diodes (LEDs) or other lamps may be provided.

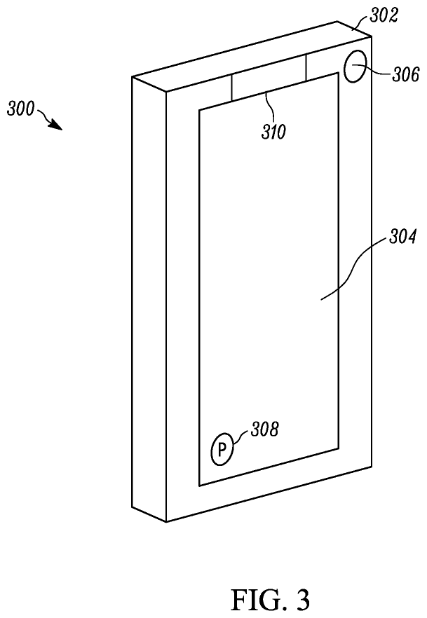

FIG. 3 illustrates a second example implementation of the ID 12, implemented as a mobile telephone 300 with a housing 302 containing components described above. A display 304 is on the housing 302 to present images as generated by the imager within the housing 302. A lens 306 is provided to focus the image on the imager behind the lens (not shown). The display 304 may be touch-enabled and may present a soft shutter actuator 308 that can be manipulated to capture an image to “take a picture” as a digital photograph. If desired, one or more lamps 310 such as light emitting diodes (LEDs) or other lamps may be provided, in the example shown, behind a bezel or display but visible therethrough. The LEDs described herein may be multi-colored to illuminate in one of multiple available colors such as green, red, and blue under command of the processor of the device.

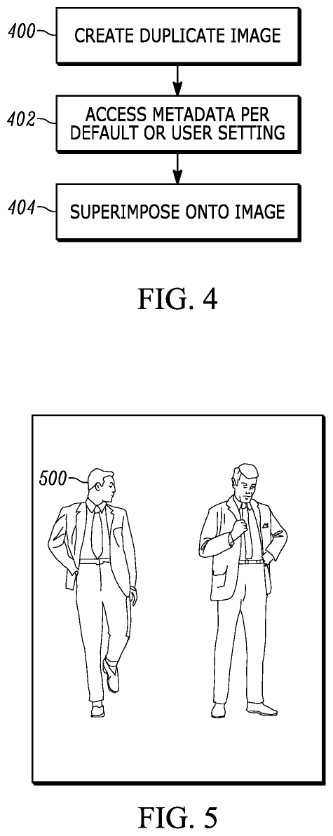

FIG. 4 shows logic that may be executed by a processor such as a camera processor implementing software that may downloaded as an application from the server 80, and/or by the server 80 receiving relevant information (such as photographs from the camera) for cloud-based metadata identification.

Commencing at block 400, if desired a duplicate of a photograph may be generated. Moving to block 402, metadata concerning the photograph is accessed. The type of metadata accessed may be by manufacturer default, modified if desired by user selection. For example, metadata representing names of people and non-human objects in the photograph may be accessed, metadata representing a place at which the photograph was taken may be accessed, and metadata representing date and time the photograph was taken as indicated by a time stamp from the imaging camera may be accessed. These are but three types of metadata that may be accessed.

Metadata representing names of people and non-human objects in the photograph as well as the place at which the photograph was taken may be generated using image recognition executed on images in the photograph. Images of people and things in the photograph may be matched against known images available on, e.g., the Internet and may be more specifically matched against known photographs h first accessing the user's social media accounts, which may return faster matches than a general Internet search. The known photographs typically are tagged with names, which can establish the metadata. Metadata representing the place at which the photograph was taken may be obtained by receiving location information from, e.g., a global positioning satellite (GPS) receiver in the camera at the time the image is taken and using the information to enter an electronic map to obtain the name of the location. Or, the metadata such as names and places may be input by the user as exemplified further below.

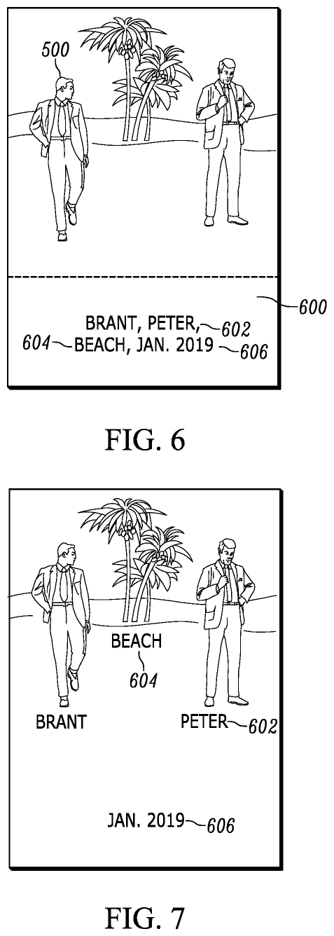

Moving to block 404, the metadata is superimposed onto one of the two duplicate photographs so that the metadata may be discerned by the human eye, leaving one image clean. FIG. 5 shows a clean photograph with two people 500 in it. FIG. 6 shows a photograph that is a duplicate of FIG. 5, except that metadata 602, 604, 606 respectively indicating the names of the people 500, the location at which the photograph was taken, and the date (and if desired time) of the photograph is visibly presented in a margin area 600 that has been established below the image in the photograph. Yet again, FIG. 7 shows a photograph that is a duplicate of FIG. 5, except that metadata 602, 604, 606 respectively indicating the names of the people 500, the location at which the photograph was taken, and the date (and if desired time) of the photograph is visibly presented onto objects of the image of the photograph. Thus, the name of each person in the photograph may be superimposed onto the image of that person, preferably in an unobtrusive manner. The metadata can also be encoded as a type of watermark. Essentially, the letters have transparency and can make any text appear more subtle.

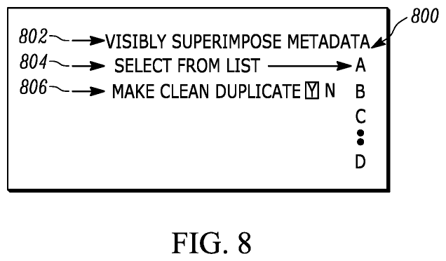

FIG. 8 illustrates a UI 800 that may be presented on any of the displays herein to establish various metadata superposition principles consistent with the present application. A selector 802 may be presented for a user to select to visibly superimpose metadata onto the image. The type of metadata may be predefined by the camera manufacturer and/or modified by allowing a user to select metadata type people's names, place names, etc.) from a selector such as a drop-down list 804. In a like manner the UI may give the user the option of presenting the metadata in a margin of the photograph (FIG. 6) or directly over images in the photograph represented by the metadata (FIG. 7). The UI may further present a selector 806 to give the user the option of making a clean duplicate photograph or not.

While particular techniques are herein shown and described in detail, it is to be understood that the subject matter which is encompassed by the present application is limited only by the claims.

What is claimed is:

1. An assembly, comprising:
a housing;
at least one processor in the housing;
at least one imager supported on the housing and configured to communicate with the processor;
at least one computer storage in the housing and comprising instructions executable by the processor to:
render a first photograph;
render metadata that does not comprise branding or copyright information and comprising at least one of: information pertaining to when the photograph was taken, information pertaining to the location of where the photograph was taken, information pertaining to at least one person in the photograph, information pertaining to at least one non-human object in the photograph; and
visually encode the metadata onto the photograph.

2. The assembly of claim 1, wherein the instructions are executable to:
visually encode the metadata onto the photograph by overwriting pixel values of the photograph with graphic data representing the metadata such that the metadata is visible on the photograph to a human eye.

3. The assembly of claim 1, wherein the instructions are executable to:
visually encode the metadata onto the photograph by presenting in a non-image margin of the photograph graphic data representing the metadata such that the metadata is visible on the photograph to a human eye.

4. The assembly of claim 1, wherein the instructions are executable to:
visually encode the metadata onto the photograph sequentially right after the image is captured.

5. The assembly of claim 1, wherein the instructions are executable to query the user for missing metadata information before visually encoding the metadata into the photograph.

6. The assembly of claim 1, wherein the instructions are executable to communicate and upload the photograph to a server, and the server encodes the metadata into the photograph, and sends the photograph with the encoded metadata back to the assembly.

7. The assembly of claim 4, wherein the metadata can be encoded on a case by case basis by a hard or soft button press on the assembly.

8. A computer storage device that is not a transitory signal and that comprises downloadable instructions executable by at least one processor to:
render metadata comprising at least one of: information pertaining to when a photograph was taken, information pertaining to the location of where the photograph was taken, information pertaining to at least one person in the photograph, information pertaining to the event that was happening, information pertaining to at least one non-human object in the photograph; and
visually encode the metadata onto the photograph.

9. The device of claim 8, wherein the instructions are executable to:
visually encode the metadata onto the photograph by overwriting pixel values of the photograph with graphic data representing the metadata such that the metadata is visible on the photograph to a human eye.

10. The device of claim 8, wherein the instructions are executable to:
visually encode the metadata onto the photograph by presenting in a non-image margin of the photograph graphic data representing the metadata such that the metadata is visible on the photograph to a human eye.

11. The device of claim 8, wherein the instructions are executable to:
visually encode the metadata onto the photograph sequentially immediately after the image is captured

12. The device of claim 11, wherein the instructions are executable to query the user for missing metadata information before visually encoding the metadata into the photograph.

13. The device of claim 11, wherein the metadata is encoded responsive to a button setting on the assembly.

14. The device of claim 11, wherein the metadata is encoded onto the photograph as text with translucence.

15. A method, comprising:
generating a digital still image; and
superimposing metadata comprising information about the digital still image onto the digital still image so that the metadata is visible.

16. The method of claim 15, comprising superimposing the metadata onto the digital still image so that the metadata is visible to a human eye viewing the digital still image.

17. The method of claim 15, comprising querying for missing metadata prior to superimposing the metadata onto the digital still image.

18. The method of claim 17, comprising executing the superimposing substantially immediately after the digital still image is generated.

19. The method of claim 16, wherein the digital still image is a first image and the method comprises generating a second image identical to the first image but without the metadata being visually superimposed thereon.

20. The method of claim 19, comprising joining the first and second images in a data structure.
